(19) United States
(12) Patent Application Publication
(10) Pub. No.: US 2023/0206262 A1
(43) Pub. Date: Jun. 29, 2023

(54) NETWORK-IMPLEMENTED COMMUNICATION SYSTEM USING ARTIFICIAL INTELLIGENCE

(71) Applicant: Swytchback, Inc., San Mateo, CA (US)

(72) Inventors: BRUCE BOWER, Menlo Park, CA (US); BLAINE NYE, San Ramon, CA (US); COLE PATTERSON, San Francisco, CA (US)

(21) Appl. No.: 18/113,532

(22) Filed: Feb. 23, 2023

Related U.S. Application Data
(63) Continuation-in-part of application No. 17/550,415, filed on Dec. 14, 2021, now abandoned.
Application No. 17/550,415 is a continuation of application No. 16/283,336, filed on Feb. 22, 2019, now abandoned.
Application No. 16/283,336 is a continuation-in-part of application No. 17/029,423, filed on Sep. 23, 2020.
(60) Provisional application No. 62/633,990, filed on Feb. 22, 2018.
(60) Provisional application No. 62/913,139, filed on Oct. 9, 2019.
(60) Provisional application No. 62/912,282, filed on Oct. 8, 2019.

(51) Int. Cl. G06Q 30/0203; G06Q 30/0201; G06N 20/00; H04L 67/306; H04L 67/50

(52) U.S. Cl. CPC G06Q 30/0203; G06Q 30/0201; G06N 20/00; H04L 67/306; H04L 67/535

(57) ABSTRACT

A network-based communication system that includes a dynamic attribution platform using Artificial Intelligence (AI), for identifying a state of a user, at a given moment, while the user is engaged in a product transaction or search journey. Based on analysis provided by the Artificial Intelligence, the system provides a series of gesture driven prompts to the user to capture the specific information from the user to allow for the product transaction to occur or journey to continue.

### CROSS-REFERENCE TO RELATED APPLICATION

This application claims the benefit as a Continuation-in-Part of application Ser. No. 17/550,415, filed Dec. 14, 2021, by Bruce Bower et al., which is a Continuation of application Ser. No. 16/283,336, filed Feb. 22, 2019, by Bruce Bower et al., which claims the benefit under 35 U.S.C. § 119(e) of provisional application No. 62/633,990, filed Feb. 22, 2018, by Bruce Bower et al., the entire contents of each of which is incorporated by reference. This application claims the benefit as a Continuation-in-Part of application Ser. No. 17/029,423, filed Sep. 23, 2020, by Bruce Bower et al., which claims the benefit under 35 U.S.C. § 119(e) of provisional application No. 62/913,139, filed Oct. 9, 2019, by Bruce Bower et al. and provisional application No. 62/912,282, filed Oct. 8, 2019, by Bruce Bower et al., the entire contents of each of which is incorporated by reference. The applicant hereby rescinds any disclaimer of claim scope in the parent applications or the prosecution history thereof and advise the USPTO that the claims in this application may be broader than any claim in the parent application.

### FIELD OF INVENTION

The present invention relates to a communication system, including but not limited to inventive algorithms and visual interactions during communications, implemented over a computer network, and analyzed by artificial intelligence.

### BACKGROUND OF INVENTION

Surveys or feedbacks are common company practices. Companies usually take a survey before launching or manufacturing of any product. This is done to know whether the product they are manufacturing will be liked by the users or not. If the feedback for survey is negative then company can save itself from huge losses that could occur if they launched that product.

In the past, surveys were performed in a very old-fashioned way by going to each user taking his/her feedback on a paper and then an analyzing panel decides the result of surveys. More recently, the surveys were conducted by telephone. The survey was typically conducted by a survey taker who presented a series of queries to the participants and recorded the answers given to the questions. As computer technology evolved and the Internet became more ubiquitous in our daily lives, survey providers began developing software which allowed for surveys to be conducted online via web pages accessed through Internet browsing software. These online survey applications were typically designed to proceed in the same manner as telephonic surveys, with online users asked to answer questions presented sequentially, with the answers recorded by the survey software.

Existing techniques for conducting online surveys are inadequate and suffer from various problems related to the way data is presented to and collected from survey participants cannot be useful in extracting the data insights and the data cannot be effectively used in remarketing or retargeting.

Current online surveys request the Login details or should share personal details to participate in the survey. As some users choose to be anonymous without sharing with personal information so they withdrew from participation.

Current online surveys mostly provide the user with a boring interface with either button or text. Which fail to interactive with the user appropriately and to retrieve more insights about the users.

As it is common for Internet users in particular to receive requests to participate in surveys and/or other forms of business-to-user interactions. The requests may come in a variety of ways, such as emails, social media and banners on web pages, and across mobile devices. It is equally common for users to ignore such requests, or to start but not finish the surveys. Clearly there is a need for an improved business-to-user communication platform to make the communication process both more relevant and more enjoyable to users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Embodiments of the invention are directed to systems and methods for efficient network-implemented communication. The interactions involved in the communications are made more enjoyable to users by using an dynamic attribution platform that uses to create the surveys, polls, quizzes or any user response related programs with the aid of Artificial intelligence (AI) to understand where the user is at the precise moment in their product or search journey and providing a series of gesture-driven prompts to the user to capture the required information along with the meta data such as response time, response hesitancy/certainty, repetition, repetivity and other human factor information gleaned by understanding the precise data attached to the gesture response to fill an information gap that persistently exists in particular between online merchants and communities and their users and members.

In some embodiments, the dynamic attribution platform provides series of gesture-driven prompts to the user which allows the platform/system to capture the specific information from the user to allow for the product transaction to occur or journey to continue. Further, based on the gesture-driven prompts are used to retrieve more data insights of the user and incorporate the data in more useful matter for effective remarketing or retargeting strategies.

In some embodiments, the artificial intelligence means which is able to precisely locate the user in their user journey by understanding both the general attributes of the user and the path user travelled to arrive to the decision point.

In some embodiments, the invention is directed towards a business user communication system that comprises of plurality of client devices; wherein each client devices can include one or more user device and one or more third party devices; a server that includes plurality of databases along with a platform to create surveys, Further the servers is operationally coupled with the client devices and third party devices over a communication network. In specific, the platform front end is configured for visual interactions that dynamically adapt to conform to the nature of information required and the back end platform continuously processes relevant catalogues based on pre-existing attributes to ensure a high degree of attribute matching accuracy.

In one embodiment of the invention the dynamic attribution platform is an open source network that allows plurality of authors to harvest the digital content, accessible via the web or other means and incorporate it into platform surveys.

In an alternative embodiment of the invention the gesture based prompts can be selected from one or more actions such as slider movement, cursor control, visual identification or speech recognition or in combination.

In an alternative embodiment of the invention the visual identification or speech recognition can be performed by using the existing hardware such as camera, microphone, cursor slider/control and thereof.

### BRIEF DESCRIPTION OF THE DRAWINGS

Various non-limiting embodiments are further described with reference to the accompanying drawings in which:

FIG. 1 is a diagram illustrating elements or components of an example operating environment in which an embodiment of the invention may be implemented.

FIG. 2 is a flowchart or flow diagram illustrating a process, method, function, or operation that may be used in implementing or using an embodiment of the inventive system;

FIG. 3 shows the system architecture of dynamic attribution platform containing different components/devices.

FIG. 4 shows the algorithmic feedback loop interfaced with core devices of the system.

FIG. 5 shows the data architecture of system platform and audience interfacing with client as intermediate.

FIG. 6 shows the detailed client account architecture and its interfacing with user.

FIG. 7-9 shows the architecture of swydget and responses collected within response data from the user survey.

FIG. 8 gives the various fields of relational analysis of different response data that are analyzed within the process

FIG. 9 shows the working of relational analysis of different response data with the help of multi-swydget system that works side-by-side.

FIG. 10a-10f shows the detailed procedure of the quizzes in web-application

FIG. 11a-11f shows the detailed procedure of the quizzes in mobile based application.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

It should be understood that the use of “user” and its synonyms such as user, respondent, customer in the present invention refers to the survey participants.

Embodiments of the invention are directed to systems and methods to make the communication process more relevant and enjoyable to the users. The system effectively obtaining and understanding a person's responses to a survey, poll, or questionnaire, feedback, quizzes, specifically for persons providing a response using a mobile device (such as a smartphone or personal digital assistant) or web-based application.

Architecture diagrams that follow hereafter include diagrams that show “swydgets”. Individual Swydgets & their response data are organized relationally so that groups of Swydgets and versions of Swydgets can be analyzed by all available data. This includes all available data regarding the Swydget and its contents as well as all available data regarding its responses, its audience, and its context. This allows for much richer insights to be derived in general, and in particular to evaluate response variability over the complete universe of relational data as the platform can consider how data was organized across any and all groupings and sequences.

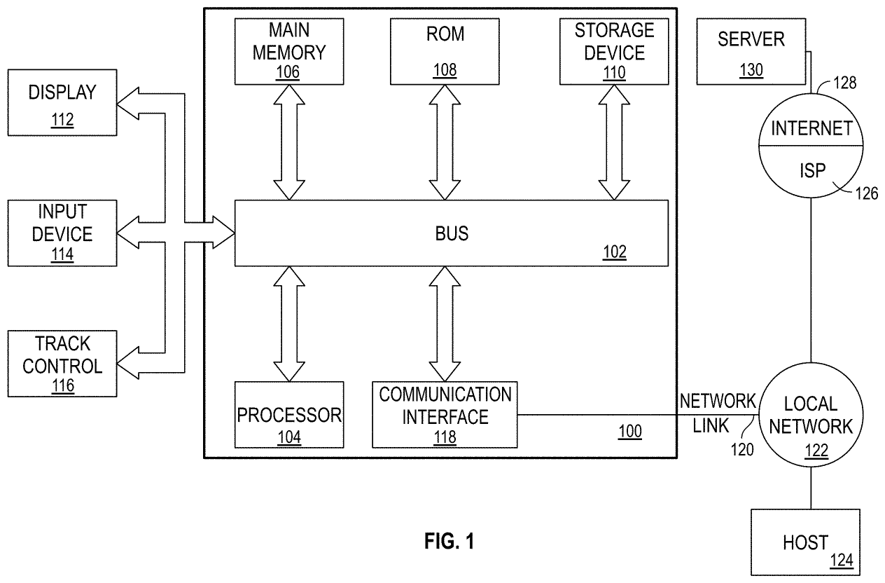

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program FIG. 1 shows the block diagram of communication system instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques

FIG. 1 is a schematic block diagram of present invention system that illustrates a computer system 100 upon which an embodiment of the invention may be implemented. Computer system 100 includes a bus 102 or other communication mechanism for communicating information, and a hardware processor 104 coupled with bus 102 for processing information. Hardware processor 104 may be, for example, a general purpose microprocessor.

Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Such instructions, when stored in non-transitory storage media accessible to processor 104, render computer system 100 into a special-purpose machine that is customized to perform the operations specified in the instructions.

Computer system 100 further includes a read only memory (ROM) 108 or other static storage device coupled to bus 102 for storing static information and instructions for processor 104. A storage device 110, such as a magnetic disk, optical disk, or solid-state drive is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is from tracking control unit 116, wherein the tracking control unit can use a mouse, a trackball, visual identification camera, microphone (speech recognition), or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

The user interacts with the questions or statements displayed to them (or to provided images, video, audio file, etc.) by interacting with the screen or display of the device. These interactions are forms of gestures, swipes, or similar motions. In some cases, the user provided interactions may include taking a picture or recording an audio file using the recording capabilities of the device. Data representing the user's responses and any desired tracking/secondary data regarding the user's interactions with the device are captured and provided to processor 104 that can be located built-in the system or located remotely.

Further the tracking control unit 116 can be used to read the gesture of the user as well as it is also used to control the cursor movement on display 112.

Computer system 100 may implement the techniques described herein using customized hard-wired logic, one or more ASICs or FPGAs, firmware and/or program logic which in combination with the computer system causes or programs computer system 100 to be a special-purpose machine. According to one embodiment, the techniques herein are performed by computer system 100 in response to processor 104 executing one or more sequences of one or more instructions contained in main memory 106. Such instructions may be read into main memory 106 from another storage medium, such as storage device 110. Execution of the sequences of instructions contained in main memory 106 causes processor 104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 110. Volatile media includes dynamic memory, such as main memory 106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge

Storage media is distinct from but may be used in conjunction with transmission media. Transmission media participates in transferring information between storage media. For example, transmission media includes coaxial cables, copper wire and fiber optics, including the wires that comprise bus 102. Transmission media can also take the form of acoustic or light waves, such as those generated during radio-wave and infra-red data communications.

Various forms of media may be involved in carrying one or more sequences of one or more instructions to processor 104 for execution. For example, the instructions may initially be carried on a magnetic disk or solid-state drive of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card, cable modem, satellite modem, or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are example forms of transmission media.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118.

The received code may be executed by processor 104 as it is received, and/or stored in storage device 110, or other non-volatile storage for later execution.

According to one embodiment of the invention, the computing system that comprises of a bus 102 that is interconnected to main memory 106, RAM 108, storage device 110, processor 104 and an communication interface 118 that is connected to local network 122 by means of network link 120 typically provides data communication through one or more networks to other data devices. For example, network link 120 may provide a connection through local network 122 to a host computer 124 or to data equipment operated by an Internet Service Provider (ISP) 126 connected to the server 130. Wherein the Computer system 100 can send messages and receive data, including program code, through the network(s), network link 120 and communication interface 118. In the Internet example, a server 130 might transmit a requested code for an application program through Internet 128, ISP 126. In specific during the request of survey the computing system 100 can access the server 130 for retrieving any information related to the survey. Further, the system is an open loop architecture the computing system 100 can access information from any part of the internet 128 but not limited to servers 130. The system is updated with all required information for the survey or quizzes and the information is displayed on the display unit 112. Based on the visual interactions on the display 112 the user selects his respondents through input device 114, further a tracking control unit 116 which is provided by the existing hardware can be useful to read/record the gestures/secondary data which can be selected from list of cursor controlling, mouse movements, track ball movement, image recognition (facial or body movements) and thereof based on the usage application. When the system sends the respondent selection data along with secondary data collected to the processor 104. The system has created a dynamic attribution platform that uses artificial intelligence in its back end. Artificial intelligence could be much more useful in survey to overcome various problems which were faced earlier and to improve decision making. In this invention artificial intelligence avoids fake surveys. Further, Artificial Intelligence (AI) while working on back end takes complete care of the user and watches each decision made by the user carefully. This information help program to analyze that how a person is making decision and the path fallowed by the person to reach that decision. If person is selecting randomly the decision path should be also determined and such kind of survey should not be neglected. This is possible by locating the journey of user while s/he selects and go through different attributes. Analyzing these attributes and the decision path of the user also give various information related to the user. This information can tell us whether the customer is willing to go through the survey and what kind of product or item s/he is willing to see and which item or product is not liked by the user. This information refines the feedback and helps in filtering results for entities by removing non relevant and useless results. It also helps in storage management as only the useful results are stored and others are removed. This technology was absent in earlier inventions hence resulting in many fake surveys which further can cause a large economic damage to the companies conducting survey. Artificial Intelligence runs the algorithms in such a way that no result should be missed and every useful result should be present on the databases

Where the back-end Artificial Intelligence (AI) platform continuously processes relevant catalogues based on pre-existing attributes that are relevant to secondary data/metadata are stored either in the server 130 or the storage memory to ensure a high degree of attribute matching accuracy. Wherein the artificial intelligence agent on the backend of the platform is able to precisely locate the user in their user journey by understanding both the general attributes of the user and the path she/he travelled to arrive to the decision point. The overall effect of this is to meaningfully increase percent of completed transactions, to provide for a much higher success rate with remarketing and retargeting efforts, and to improve the user experience, based in part on increased cognitive engagement required by Swytchback™ gesture-driven front end.

The business-user communication system in a dynamic attribution platform has that uses Artificial Intelligence (AI) to identify whether the user is at the given moment in their product or search journey and the provides a series of gesture-driven prompts to the user which allow to capture the specific information from the user to allow for the product transaction to occur or journey to continue so as to fill the information gap that persistently exists in particular between online merchants and communities and their users and members.

In an exemplary embodiment of the invention, the Artificial Intelligence (AI) is used to precisely locate the user in their moment and search journey the attributes of the user which is detected by the tracking control unit 116. Wherein the tracking control unit 116 tracks the gestures of the user using existing hardware of the computing devices such as camera, microphone, mouse, touch interface and thereof.

In an exemplary embodiment of the invention, the system also tracks the user travelling path to reach the decision point for example the system tracks all actions performed on the computing system 100 such as skips questions, order of answering questions and thereof.

Dynamic attribute platform uses artificial intelligence agent to precisely locate the user in their user journey by understanding both the general attributes of the user and the path she/he travelled to arrive to the decision point.

In an exemplary embodiment of the invention, the computing system 100 can select different gesture-driven prompts accordingly for example when the response has to be updated from computing system 100 that can be from desktop or laptop the system can consider the mouse movements, cursor movements and thereof depending the sensing means available. In another example if the response has to be updated from a mobile device the system can request to access the visual means such as camera for reading facial expression or body gestures. Further even the microphone (voice or speech processing software) or slider control can able to track the user gesture or mood by upon comparing with predefined attributes. Which would help in finding deep insights and also increase the cognitive engagement of the user in order to meaningfully increase percent of completed transactions.

In an exemplary embodiment of the invention, tracking control unit can also be used to control the cursor movement on the display. This input device typically has two degrees of freedom in two axes, a first axis (e.g., x) and a second axis (e.g., y), that allows the device to specify positions in a plane.

In an embodiment of the invention, the platform allows a plurality of researchers to draw specific insights by creating highly visual surveys and quizzes that both cognitively engage the respondent at a high level and at the same time capture meaningful insights, both on a single use basis and longitudinally.

In an exemplary embodiment of the invention, the tracking control unit 116 captures the gesture based response that includes secondary insights from the users based on the answers provided and also by the means by which the respondent answered, including response time, response hesitancy/certainty, repetition, receptivity and other human factors.

Swytchback™ or dynamic attribution platform tracks engagement across its platform without requiring login or the sharing of personal information so as to build intelligent user profiles based on all activity that occurs on the platform. This is accomplished through a dynamic user identification assignment system that identifies anonymous users in an individual account structure that can be used for targeted and retargeted advertising when populated with web-derived information. This in turn feeds the prediction engine which dynamically assigns either a sequential interaction or pattern of interactions designed to elicit more relevant data, or which can make a recommendation at that instant.

In an exemplary embodiment of the invention, the gesture-driven prompts tracks engagement of the user without requiring any login or sharing of personal information and build intelligent user profiles based on all the activity of the user that occurs on the platform.

The dynamic attribution platform has front-end and back-end system; wherein the front end's visual interactions dynamically adapted to conform to the nature of the information the platform needs to elicit from user at that particular moment.

The back-end of dynamic attribution platform continuously process relevant catalogues based on pre-existing attributes that are already stored in the server and ensure a high degree of attribute matching accuracy so as to precisely locate the user in their user journey by understanding both the general attributes of the user and the path she/he travelled to arrive to the decision point he overall effect of this is to meaningfully increase percent of completed transactions, to provide for a much higher success rate with remarketing and retargeting efforts, and to improve the user experience, based in part on increased cognitive engagement required by platform gesture-driven front end.

According to one exemplary embodiment of the invention, the system tracks engagement across its platform without requiring login or the sharing of personal information so as to build intelligent user profiles based on all activity that occurs on the platform. This is accomplished through a dynamic user identification assignment system that identifies anonymous users by the gesture-driven prompts in an individual account structure that can be used for targeted and retargeted advertising when populated with web-derived information. This in turn feeds the prediction engine which dynamically assigns either a sequential interaction or pattern of interactions designed to elicit more relevant data, or which can make a recommendation at that instant.

The system/platform interactions are catalogued by an anonymous user identification system, and the platform intelligently tracks which interactions have occurred for that particular user so that even partial completions of quizzes or surveys are retained and can populate the results for a quiz or survey even if completed later.

All items in the platform are organized relationally with respect to any other data or response options that appear in context with that specific data even if that data appears in more than one setting more than one time. This is achieved, in part, by using relational entity wrappers which are an essential component of the Swytchback™ relational data structures and allow for real time recommendations based on dispersed data sets. The system captures all relational elements of each piece of Swytchback™ data no matter where or in what context that data appears, including which individual user has interacted with that data and how. This allows Swtychback™'s intelligent agents to see data relationships across a much broader and diverse set of environs allowing for far deeper insights than are available on traditional online survey platforms.

In an exemplary embodiment of the invention, the platform is said to dynamic attribution platform has it reads different attributes of the user along with response and compare the relevant data with the gesture data to find out deep insights of the survey.

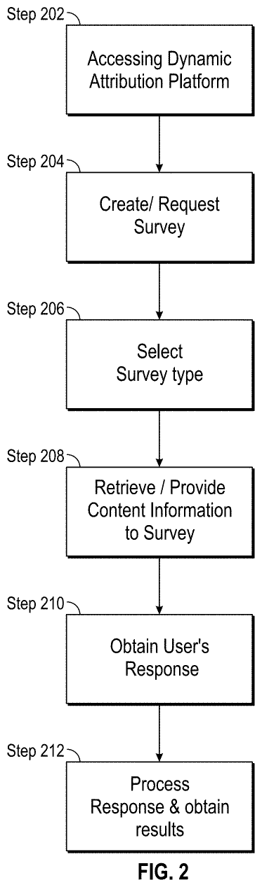

FIG. 2 is a flowchart or flow diagram illustrating a process, method, function, or operation that may be used in implementing or using an embodiment of the inventive system. As shown in the figure, initially in the Step 202 for implementation of the requested survey the research entity has to access the dynamic attribution platform; wherein the research entity can be either the survey taker but not limited to individual user or a company. In Step 204 the research entity can either create or request survey further the dynamic attribution platform, the platform has different kinds of surveys models such as binary response, scalar response and forced ranking where the research entity has to select at least one type of survery model as mentioned in Step 206; after selecting the survery type in step 206 the research entity has to fill the required content information for the survey as mentioned in step 208; wherein the dynamic attribution platform is an open frame architecture allows authors to harvest any amount of digital content, accessible via the Web or otherwise, and incorporate it into surveys. Platform does so either in its own hosted environment or through click-through such as third party or different environment/locations. In Step 210 the user is provided a survey details displayed on the user interface of the user device where the user can provide his response regarding the survey. Further the system is equipped with an means to derive additional data or meta data from the user; wherein the metadata can be derived based on the gesture based prompts such as slider bar control, cursor control, visual identification, speech recognition and thereof. In step 212, the system uses the user response along with derived data and process the information to extract results and deep insights from the information and further the extracted results and the deep insights can be transported for downloaded in Excel, Word, PDF, PPT and thereof based on user preferences.

In an exemplary embodiment of the invention, the platform supports a range of validated survey approaches including forced choice, scalar, binary and cascading logic using visual based interfaces.

According to one embodiment of the invention, the business to user platform can be used as either as an stand-alone application or it can be incorporated into any e-commerce or service site/app such as shopping, restaurants, websites for improving the efficiency by creating an interest to increase continue the questionnaire's, surveys, polls or quizzes and thereof.

According to one exemplary embodiment of the invention, tracking control unit 116 of FIG. 1 can use either a camera or microphone, cursor control, mouse track ball. In specific, the tracking unit 116 uses the camera for extracting gesture based prompts either by analysing facial expressions or body movements. Further the system can also incorporate with “track silent mode”.

Wherein the “track silent mode” which captures the gestures by activating the camera or microphone in silent mode. Generally in prior arts, during activation of camera the device automatically show the image of the camera focus on the display screen. But during “track silent mode” even though if the camera is activated for imaging the gesture. But still the camera will not display the gesture on the screen that it is tracking/filming of the computing device 100.

In order to activate the “track silent mode” the system has to take appropriate permission from the user. So the platform doesn't create any disturbances to the user while providing the responses.

User can also provide with an option to disable the “track silent mode” and then secondary data/meta data can only be extracted using other different tracking sources such as microphone, mouse control and thereof.

In an exemplary embodiment of the invention the platform can able to take one or more inputs from the tracking control unit 116 along with responses.

Optionally, a small light indication can be provided to the user device during activation of “track silent mode”.

Based on the inputs received from the selection data and secondary/meta data in the analytics & reporting tool of the platform can able to draw deeper insights as these elements or processes may include functions, operations, models, or other forms of mathematical/statistical processes that may be used to analyze and evaluate the response data and/or metadata received from multiple survey takers and/or accounts in order to generate insights into the operation of the platform and/or survey creation, distribution, and processing operations—such features, elements, operations, functional capabilities may include: capabilities for aggregating the metadata for multiple survey takers across one or multiple survey maker accounts; enabling the application of machine learning and/or other advanced data mining and analysis techniques to assist in identifying one or more survey, survey taker, or device characteristics that contribute to specified goals or results and enable the generation of recommendations with regards to survey construction, survey contents, desired survey takers, desired devices, etc. where applicable to assist survey makers or administrators to achieve better response rates and more reliable responses; to generate recommendations or content to provide to a user or set of users based on one or more of survey responses, survey/user associated metadata, behavioural models, etc.

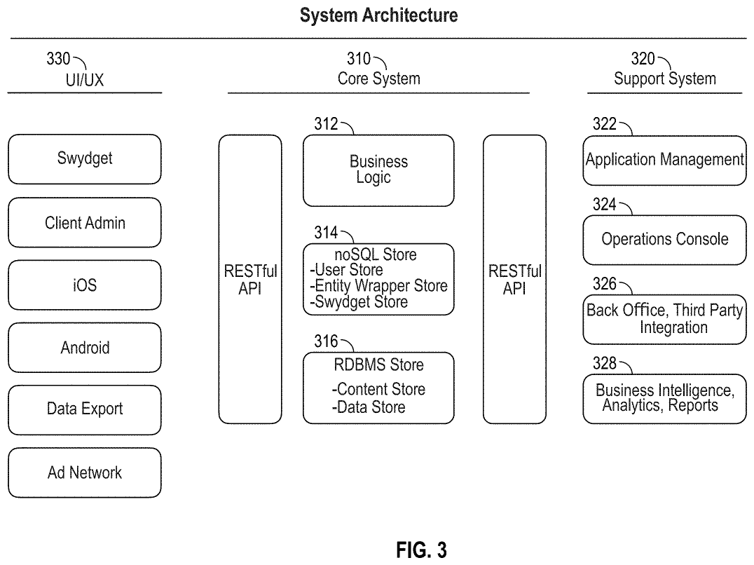

FIG. 3 is a system architecture of a dynamic attribution platform which is broadly divided into three devices/components such as user interface (UI/UX) 330, core system 310 and support system 320. In specific, core system 310 has multiple sub-system such as Restful Api's, business logic 312, SQL store 314, RDMS store 316; The support system 320 that comprises of different sub-systems such as application manager 322; operation console 324; back office third party 326; business intelligence analytics, reports 328; which can be used in analysing the response and extract deep insights from the information and further proceed with an option to export the data in the required format.

The user interface (UI/UX) 330 of the system architecture is also known as the front-end of the system and responsible for visual interactions that dynamically adapt to conform to the nature of the information the platform needs to elicit from the user at that particular moment. Wherein the main purpose of the UI/UX is to input the response from the user device and dynamically adapt the interface based needs to elicit from the user. Further the user interfaces or user interface elements may also include definitions or representations of device user swipes or interactions with a device that the tenant may desire to be used in responding to their surveys or polls.

The user interface (UI/UX) 330 of the system can be supported on different kind of software platform such as android, iOS, data export, Ad network, Swydet, client admin and thereof.

Once the response from UI/UX 330 has been retrieved it process the information to the core system 310 which comprises of multiple sub-system such as Restful Api's, business logic 312, SQL store 314, RDMS store 316;

Each core system 310 may contain specific data (device user response data, device user metadata/secondary data, tenant account or business information, tenant specifications for surveys or survey data processing, etc.) that is used as part of providing a range of tenant-specific services or functions, including but not limited to survey creation and distribution, survey response evaluation and analysis, generation of recommendations, decision tools, metadata processing and analysis, storage and marketing of data obtained from takers of surveys provided to the takers by the tenant, etc. Data stores may be implemented with any suitable data storage technology, including business logics 312, structured query language (SQL) 314 based relational database management systems (RDBMS) 316.

Where the support system 320 which has different sub-system which takes care of all support related queries can include application management 322 software that manages the availability of network-cantered applications within an organization, such as email, intranets and client/server, operations console 324 which access information about response details, predefined attributes information located in the server engines. Then system integrates the information of the back-end/third party platform continuously 326 processes relevant catalogues based on pre-existing attributes to ensure a high degree of attribute matching accuracy for highest, third party 326, business intelligence, analytics and reports 328 where the sub-system analyses the information that is retrieved from the user response along with the gesture-driven prompts and draw deeper insights and transport and then transporting the results in the required format.

As noted, in accordance with one embodiment of the invention, the “enterprise” version of the dynamic attribute platform includes multi-user authentication (e.g., survey or poll distribution companies, marketing consultants, businesses, governmental entities, etc.) with a set of related applications, data storage, functionality, authorization and accounting system that may be operated by an entity that is realized by the real time interaction amongst the data entities on the platform. This also allows dynamic attribution platform to make unique recommendations based on real-time entity analysis, as well as allowing for dispersed authentication, authorization and accounting capabilities. These applications and functionality may include ones that a survey maker/tenant uses to manage various aspects of its operations as they relate to surveys or polls. For example, the applications and functionality may include providing web-based access to certain business information systems, thereby allowing a tenant with a browser and an Internet or intranet connection to view, enter, process, or modify certain types of information.

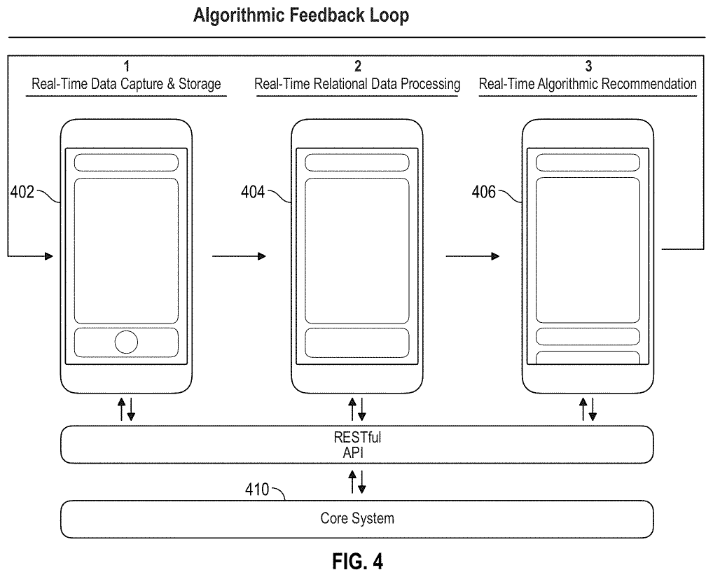

FIG. 4 is an algorithmic feedback loop interfaced with core devices of the system comprises of feedback loop interfaced with core devices of the system represents about a level by level processing of the data. In specific a core system 410 is connected to the computing system 402 by means of RESTful Api. Where the computing system 402 captures the real-time data or response from the user and store it the data available and the information is real-time relational data processing in real time by the processor and compare the processing results with predefined attributes, destination path and gesture-based prompts to real-time recommendations 406.

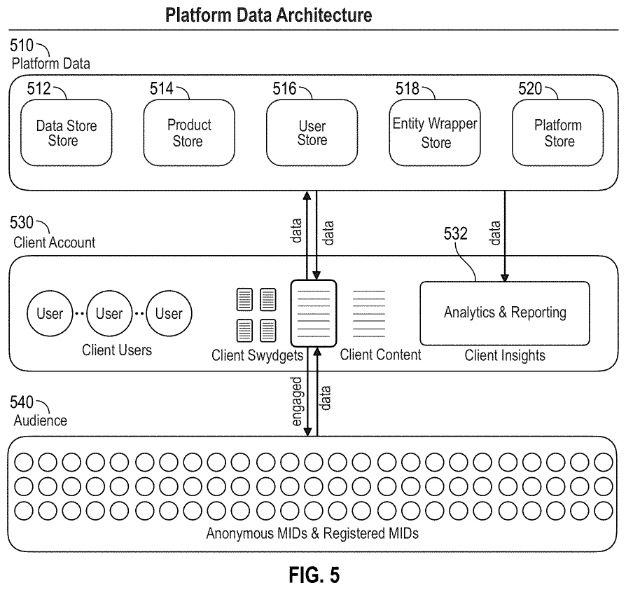

FIG. 5 is a data architecture of system platform 510 and audience interfacing 540 through a client account 530. Where the platform 510 comprises of different data such as data store 512, product store 514, user store 516, entity wrapper store 518, platform store 520 which stores all specific data that are related to products, users, data and thereof.

Wherein an exemplary embodiment of the invention that the system platform 510 can mounted in remote location such as server.

Wherein the audience platform 540 has a plurality of user which can be further sub-divided into anonymous and registered users are engage with system platform 510 by means of client account 530 which includes analytics and reporting module, users, client content which were used to create surveys with content information.

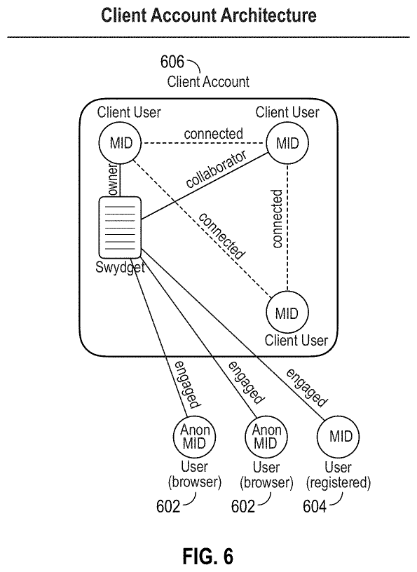

FIG. 6 shows the client account architecture and its interfacing with user. Wherein the Swytchback™ tracks engagement across its platform without requiring login or the sharing of personal information so as to build intelligent user profiles based on all activity that occurs on the platform. Data entities are created on the name or identity of user (602, 604) such as anonymous user 602 and registered user 604 trying to engage with the client account 606. Wherein the client account comprises or different sub-elements and devices. Data entities are created on the basis of items or objects. Single survey can have multiple items or objects. These entities when connected with the wrapper database the data content is attached to every entity. So this unique feature do not require user data to be extracted from user. It helps in blocking multiple or fake user accounts. The intelligent software build user profiles according to the attributes taken from the user. Hence this also helps in finding which users are interested in product and which are not. This is done with the help of an intelligent client account system. This system identifies anonymous users in as individual account structure and this data can be used for targeted and retargeted advertising when populated with web-derived information. This in turn feeds the prediction engine which dynamically assigns either a sequential interaction or pattern of interactions designed to elicit more relevant data, or which can make a recommendation at that instant. Structure contains a large amount of anonymous user details where each user have their unique attributes and occupying different random location in the memory. After execution of this system it identifies the users with similar attributes and similar area of interest so user could be targeted and the approach for advertisement or selling product could be different depending on the entity analysis for different users. These targeted audience is then separately added to the databases and then further used to interact or advertise separately with different approach and the survey could be conducted in more relevant manner so no populated audience is there for the survey in any web-derived information. This method of survey will be helpful for the survey to get only relevant users for survey and removing trash information from the data. Trash information may include fake user account, non-human or robotic answering machine, or same user with multiple user accounts, etc. For paid surveys such technology gives an advantage over public surveys over a web-domain.

All items in the Swytchback™ system are organized relationally with respect to any other data or response options that appear in context with that specific data even if that data appears in more than one setting more than one time. This is achieved, in part, by using relational entity wrappers which are an essential component of the Swytchback™ relational data structures and allow for real time recommendations based on dispersed data sets. Entities are any object which exists and in our invention entity refers to the unique items created by the client on which survey is been conducted or is related to survey. That entity is main identification of that item and all the data related to that item is connected to that entity through wrapper. So in databases entity wrapper are relationally arranged which stores each and every data related to any particular entity. It could be possible that a single data or response may be present in more than one entity or is related to many wrappers. This is done so none of the response by any anonymous user or identified user should not be missed and decisions could be more précised. These unique identifications known as entities are then easy to identify by client while taking results of any survey and covers all the related data. This relational division of entity wrappers also help in real-time analysis of the entities on later stage. These entity wrapper are stored in entity wrapper store in noSQL store in the core system. Entity wrapper are present at the platform of system where they can be excessed by the client through swydget store and user store which are interfaced with entity wrapper.

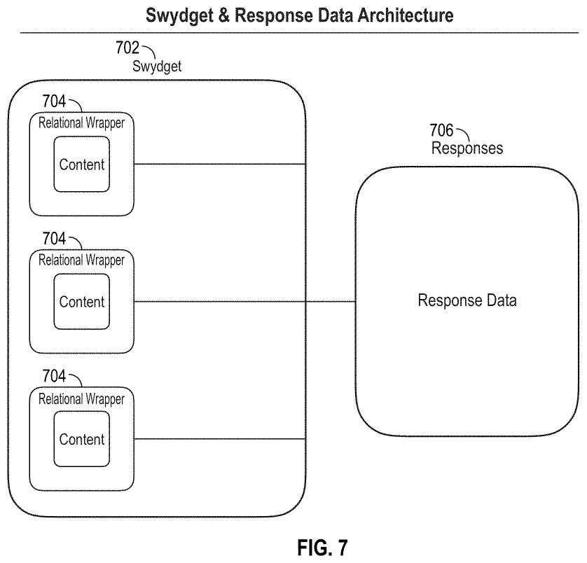

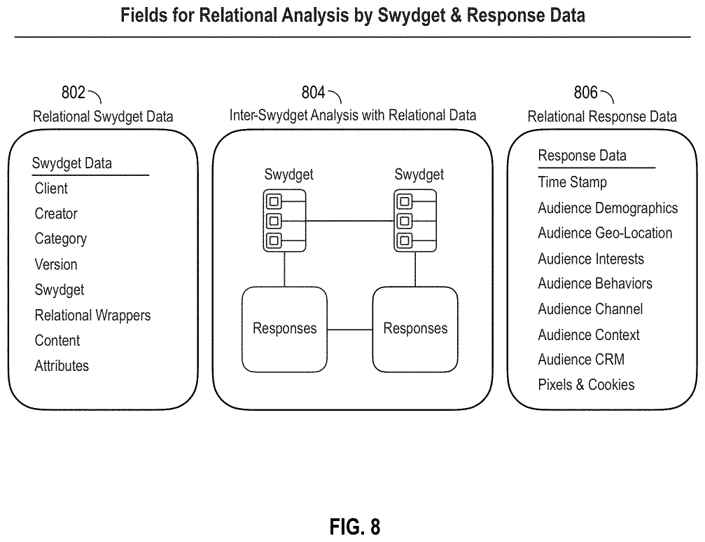

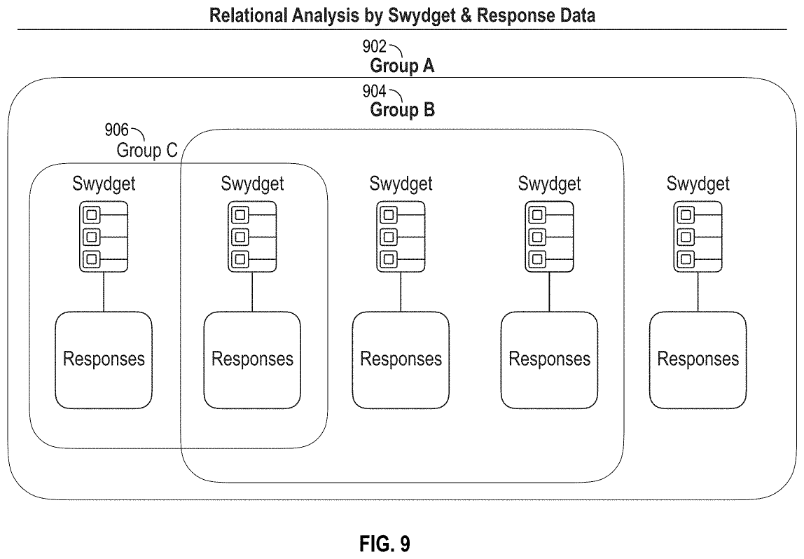

FIG. 7-9 describes about a response architecture which comprises of swydet 702 and response data 704 which were used to store the content in the platform and provided in the online survey and provided to the user for responding 704.

In an embodiment of the invention the platform can have relation data 802 such as client, creator, category, version, content and thereof. Further a relational response 806 data such as timestamp, audience demographics, CRM and thereof by using Inter-Swydget Analysis with Relational Data 804.

According to one exemplary embodiment of the invention is about a slider-bar through options where the user must navigate through all available choices in chunk; once they have viewed all choices “select” button is activated.

According to one exemplary embodiment of the invention is all about account management & analysis where the system can also provide the results in geo-maps.

The system has a content library which stores all kinds of survey stored in the database. Wherein the platform allows the system to allow to participate and also to create surveys and provided content information in the library or can be extracted from any open source and also available for content media preview.

The system further also allows the platform to edit the content attributes of the system. Further the system can able to create a survey model which includes likes questioning, editing according to our preference such as binary responsive survey, scalar responsive survey, forced ranking survey which are already known to the person skilled in the art.

In an exemplary embodiment of the invention that the surveys can be sent to our personal contacts stored in the address book.

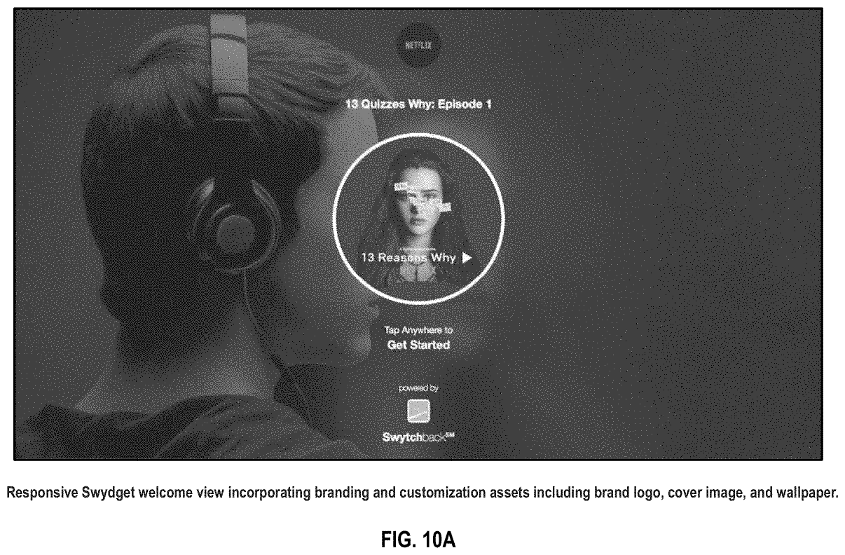

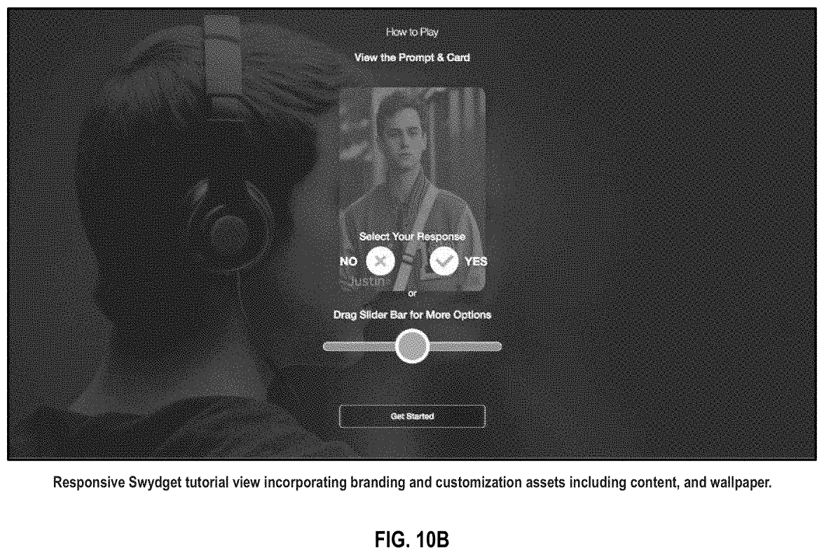

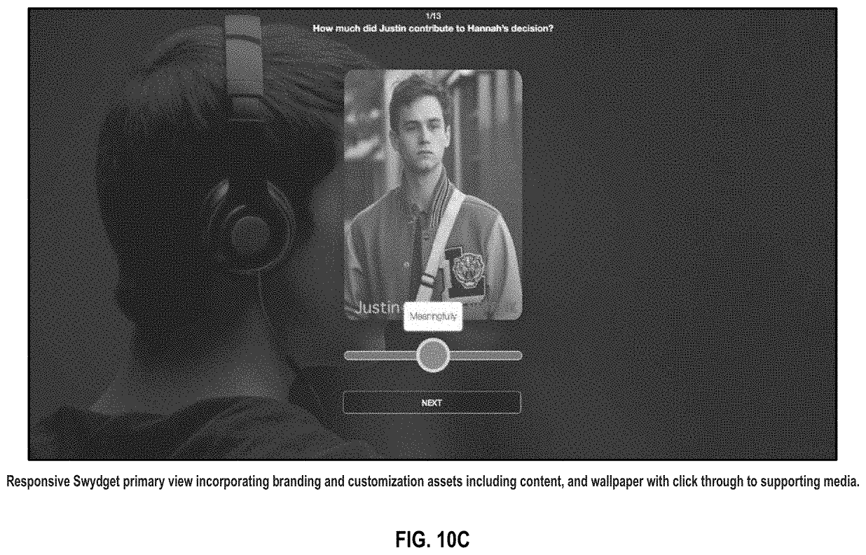

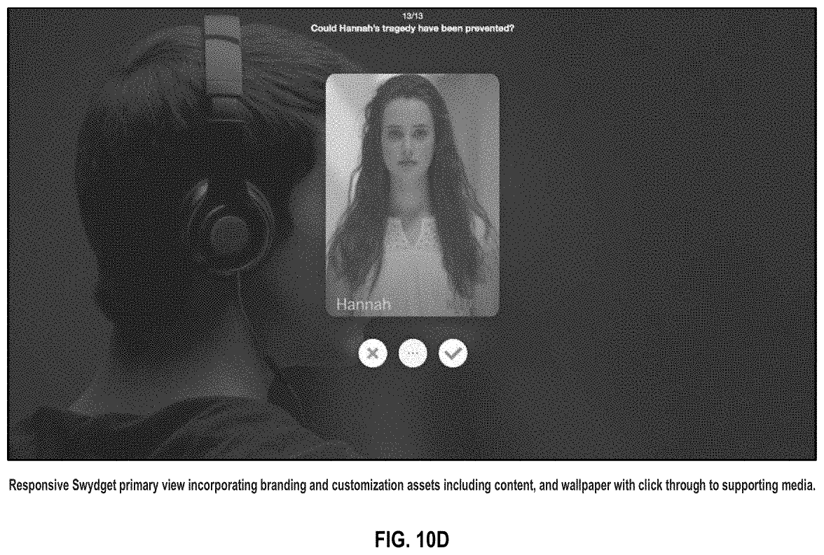

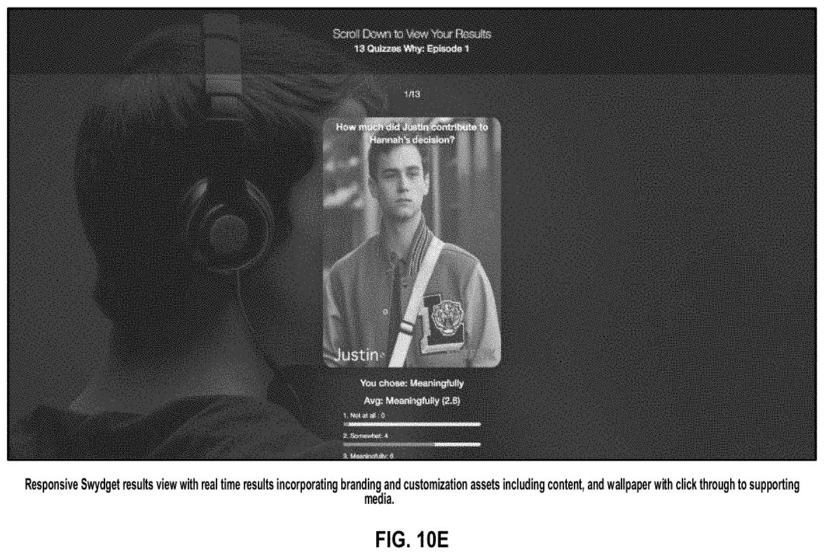

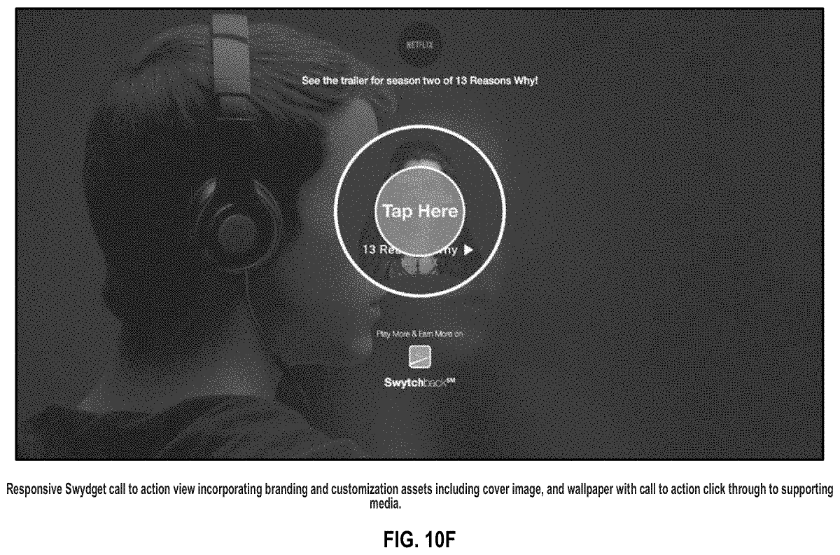

FIGS. 10a to 10f represents an customer interactions on responsive web-app desktop which includes the system can ask some random question as shown in the example 1:

The responsive shows a welcome view incorporating branding and customization assets including brand logo, cover image and wall paper. Where a list of 13 questions are asked to analyse. First of the system asks to tap anywhere to get the system started.

The system prompts& card with a slider bar and next option where the slider bar is to obtain the response such as high/medium/low and thereof and after answering the particular question the user can select the next button to respond to the next question and this continues until the whole set of questions are answered. Where the artificial intelligence agent in the system helps to track at which we are and the response we have provided through slide-bar. Further the slider bar response can also be called as gesture-based prompt useful in understanding the secondary data/meta data such as reaction time, hesitance and thereof and the path used by the user to reach the destination.

In another embodiment of the invention, the system can activate or ask the computing system to read other parameters like mouse ball tracking, no of clicks, cursor control and thereof. Alternatively the system can also activate camera/webcam or microphone is the computing system equipped with and the platform has a means to display the score of previous email.

Additionally the system can also have an option to display the global percentage of response provided different users or friends.

In an embodiment of the invention the system can consider one or more gesture inputs for efficient results. Further the results are processed to extract deep insights.

Further the system can be useful in extracting real-time recommendations based on the relatively data processed.

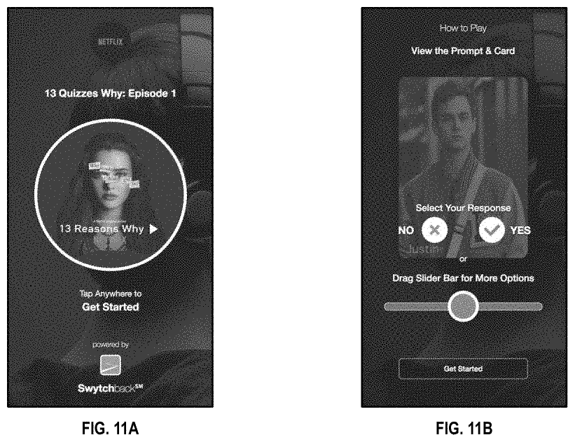

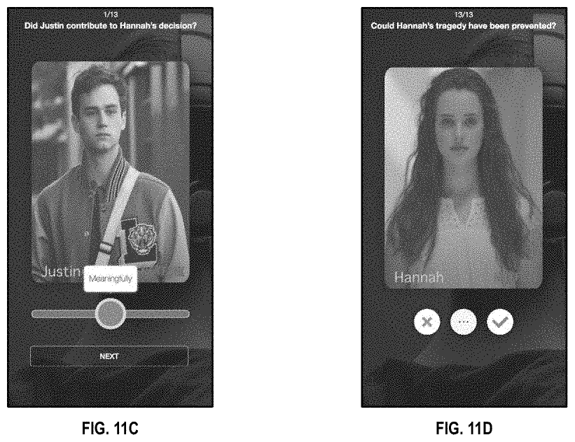

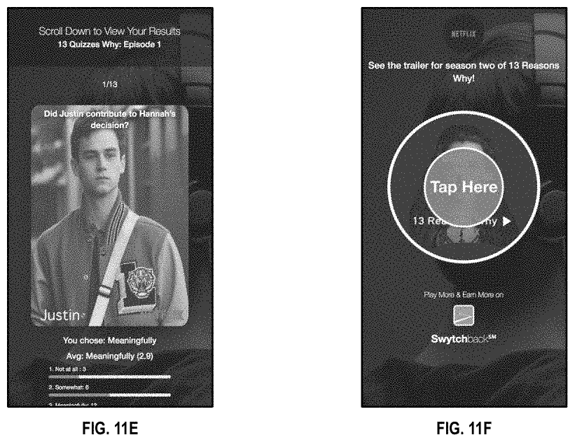

FIGS. 11a to 11f represents the detailed procedure of the quizzes in mobile based application as shown in example 2:

The responsive shows a welcome view incorporating branding and customization assets including brand logo, cover image and wall paper in a mobile-view or mobile based application. Where a list of 13 questions are asked to analyse. First of the system asks to tap anywhere to get the system started.

The system prompts with a picture & card with a slider bar and next option where the slider bar is to obtain the response such as high/medium/low and thereof and after answering the particular question the user can select the next button to respond to the next question and this continues until the whole set of questions are answered. Where the invention removes the prior button or text related feedback input which are boring. The artificial intelligence agent in the system helps to track at which we are and the response we have provided through slide-bar. Further the slider bar response can also be called as gesture-based prompt useful in understanding the secondary data/meta data such as reaction time, hesitance and thereof and the path used by the user to reach the destination.

In another embodiment of the invention, the system can activate or ask the computing system to read other parameters like visual identification, mouse ball tracking, no of clicks, cursor control and thereof. Alternatively the system can also use camera or microphone to compute the facial features or body movements to understand the gesture apart from the slider bar.

Additionally the system can also have an option to display the global percentage of response provided different users or friends.

In an embodiment of the invention the system can consider one or more gesture inputs for efficient results. Further the results are processed to extract deep insights.

Further the system can be useful in extracting real-time recommendations based on the relatively data processed.

In an alternative embodiment of the invention the visual identification or speech recognition can be performed by using the existing hardware such as camera, microphone, cursor slider/control and thereof.

According to one embodiment of the invention, the platform comprises of a cursor slider which is presented on the user interface of the computing device can have multiple stages for example 2, 3 or 5 or even free moving slider which can scale attached for knowing the selected movement.

According to an exemplary embodiment of the invention, the platform can be applied standalone application or can be incorporate to any site such as e-commerce and thereof for effective survey and increasing the rate enthusiasm to complete the survey.

All references, including publications, patent applications, and patents, cited herein are hereby incorporated by reference to the same extent as if each reference were individually and specifically indicated to be incorporated by reference and/or were set forth in its entirety herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
supporting a range of validated survey approaches including forced choice, scalar, binary, and cascading logic using visual based interfaces;
while a user is engaged in a product transaction or search journey, causing an artificial intelligence mechanism to identify a current state associated with the product transaction or search journey;
based on the state determined by the artificial intelligence mechanism, providing a series of gesture-driven prompts to the user which capture specific information from the user to allow for the product transaction or search journey to continue, wherein the step of identifying the current state is based on both general attributes of the user and a path the user travelled to arrive at a decision point;
capturing a gesture-based response structure including secondary insights from respondents/users based on the answers provided and also by the means by which the respondent answered, including response time, response hesitancy/certainty, repetition, repetivity and other human factor information gleaned by understanding the precise data attached to the gesture response.

2. The method of claim 1, wherein the step of providing the gesture-driven prompts to the user increases cognitive engagement of the user in order to meaningfully increase percent of completed transactions.

3. The method of claim 1, further comprising creating highly visual surveys and quizzes that both cognitively engage the respondent at a high level and at the same time capture meaningful insights, both on a single use basis and longitudinally.

4. The method of claim 1, wherein the gesture-driven prompts are used to track engagement of the user without requiring login or the sharing of personal information and also to build intelligent user profiles based on all the activity of the user that occurs on a platform.

5. The method of claim 4, wherein the tracking of engagement of the user is accomplished through a dynamic user identification assignment system which identifies anonymous users in an individual account structure that can be used for targeted and retargeted advertising when populated with web-derived information.

6. The method of claim 5, further comprising:
feeding the information on the identified users to a prediction engine, the engine dynamically assigns either a sequential interaction or pattern of interactions designed to elicit more relevant data, or which can make a recommendation at that instant.

7. The method of claim 1, further comprising providing a platform on which information is organized relationally with respect to any other data or response options that appear in context with that specific data even if that data appears in more than one setting more than one time.

8. The method of claim 7, wherein the relational data structures are used for real time recommendations based on dispersed data sets, and wherein the data relationships across are broader and diverse set of environs allowing for far deeper insights.

9. The method of claim 1, wherein all communications in a platform are catalogued by an anonymous user identification system, and the platform intelligently tracks which interactions have occurred for that particular user so that even partial completions of quizzes or surveys are retained and can populate the results for a quiz or survey even if completed later.

10. The method of claim 1, further comprising providing a platform that includes a front end and a back end, the front end of the platform is for visual interactions dynamically adapt to conform to the nature of the information the platform needs to elicit from the user at that particular moment, and the back end of the platform continuously processes relevant catalogues based on pre-existing attributes to ensure a high degree of attribute matching accuracy.

11. The method of claim 10, further including an open frame architecture which allows a plurality of authors to harvest the digital content, accessible via the web or otherwise, and incorporate it into platform surveys.

12. A business-user communication system comprising:
a plurality of client devices, the client devices including one or more user device and one or more third party devices;
at least one server including a plurality of databases;
the server further including a platform, the server is operationally coupled with the client devices and third-party devices over a communication network, the platform is configured for visual interactions dynamically adapt to conform to the nature of the information the platform needs to elicit from the user at that particular moment, and the back end of the platform continuously processes relevant catalogues based on pre-existing attributes to ensure a high degree of attribute matching accuracy, and
the platform is configured for:
allowing a plurality of authors to harvest the digital content, accessible via the web or otherwise, and incorporate it into platform surveys;
identifying at least one user at a given moment in their product or search journey;
providing a series of gesture-driven prompts to the user which capture the specific information from the user to allow for the product transaction to occur or journey to continue, wherein the gesture-driven prompts to the user is to increase the cognitive engagement of the user in order to meaningfully increase percent of completed transactions; and
capturing the gesture-based response structure including secondary insights from respondents/users based on the answers provided and also by the means by which the respondent answered, including response time, response hesitancy/certainty, repetition, repetivity and other human factor information gleaned by understanding the precise data attached to the gesture response.

13. The system of claim 12, wherein the gesture-based prompts can be selected from either slider movement, cursor control, visual identification or speech recognition or in combination.

14. The system of claim 13, wherein the gesture-based prompts is also provided with a “track silent mode” which prevents the screen from displaying the camera filming content or gestures.
